(19) United States
(12) Patent Application Publication
(10) Pub. No.: US 2025/0002046 A1
(43) Pub. Date: Jan. 2, 2025

(54) System And Methods For Providing Driver Assistance Alerts Using An End-To-End Artificially Intelligent Collision Avoidance System And Advanced Driver Assistance Systems

(71) Applicant: HYPRLabs, Inc., San Francisco, CA (US)

(72) Inventors: Tim Kentley-Klay, San Francisco, CA (US); Werner Duvaud, Neuilly-Sur-Seine (FR); Aurèle Hainaut, Paris (FR); Maxime Deloche, Montpellier (FR); Ludovic Carré, Paris (FR)

(73) Assignee: HYPRLabs, Inc., San Francisco, CA (US)

(21) Appl. No.: 18/731,115

(22) Filed: May 31, 2024

Related U.S. Application Data
(60) Provisional application No. 63/524,213, filed on Jun. 29, 2023.

(51) Int. Cl. B60W 60/00; B60Q 9/00; B60W 30/09; B60W 50/14

(52) U.S. Cl. CPC B60W 60/0016; B60Q 9/008; B60W 30/09; B60W 50/14; B60W 2420/403; B60W 2556/00

(57) ABSTRACT

The technology disclosed teaches a system and methods for providing driver assistance alerts to a driver using an end-to-end artificially-intelligent advanced driver assistance system. The technology disclosed further includes receiving environmental data for a sequence of driving states including at least video from a camera, returns from an optical sensor, and location data from a GNSS receiver, wherein the camera, the optical sensor, and the GNSS receiver are coupled to a processor carried by a vehicle, processing the environmental data as input to an end-to-end neural network, wherein the end-to-end neural network is trained to generate prescriptive steering and speed control actions in response to a present driving state, analyzing hidden layer data and output data from the end-to-end neural network to estimate collision avoidance data, and presenting, to the driver, a user interface including driver assistance alerts based on the collision avoidance data.

### PRIORITY APPLICATION

This application claims priority to and the benefit of U.S. Provisional Application 63/524,213 filed 29 Jun. 2023, titled “Scalable Training and Validation for an End-To-End Autonomous Driving Model” by inventors Tim Kentley-Klay, Werner Duvaud, Aurèle Hainaut, Maxime Deloche, and Ludovic Carré (HYPR 1001-1).

### RELATED CASES

This application is related to the following commonly owned applications, all of which are incorporated by reference for all purposes:
U.S. patent application Ser. No. 18/431,827, filed 2 Feb. 2024, titled “Multi-Functional Inventory Storage and Delivery System” by inventors Tim Kentley-Klay and Aditya Narayan (HYPR 1000-2); and
U.S. Provisional Application 63/443,342 filed 3 Feb. 2023, titled “Multi-Functional Inventory Storage and Delivery System” by inventors Tim Kentley-Klay and Aditya Narayan (HYPR 1000-1).

### FIELD OF THE TECHNOLOGY DISCLOSED

The technology disclosed relates to end-to-end neural networks configured for autonomous and semi-autonomous driving. In particular, the technology disclosed relates to a scalable method and apparatus for training and validating an end-to-end network configured for autonomous and semi-autonomous driving.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the technology disclosed.

Autonomous driving technology, appealing for its benefits in driver satisfaction and safety, is already evident in semi-automated advanced driver assistance systems (ADAS) for tasks like lane changing, speed control, and parking. These advancements not only enhance driver convenience and comfort but also hold promise for public safety, infrastructure, and vehicle durability by reducing accidents. Additionally, autonomous driving technology extends to various robotic applications such as space probes, industrial robots, military drones, and delivery robots, addressing concerns in efficiency, cost, quality, and environmental impact. For example, the E-commerce industry can benefit from the use of autonomous delivery robots that improve upon efficiency, cost, quality, and environmental impacts of traditional delivery methods.

Despite the decades of research on autonomous vehicle development, fully autonomous vehicles are not yet available for individual use on the market. Waymo has made progress on its autonomous fleet, but only for taxi service, so far. Although progress is substantial, safety and reliability are still lacking. Traditional autonomous driving systems, characterized by an aggregation of independent submodules, are challenging to optimize due to the enormous volume of data necessary to train these models. Furthermore, the manual labelling of this data necessary for the artificial intelligence systems configured for traditional autonomous driving is expensive. Many data formats required by traditional autonomous driving systems, such as pre-built maps, are not only expensive to construct and label, but pose risks to safety and generalizability due to the limited capacity to react in situations where the real-world environment does not correlate to the map as expected.

The drawbacks associated with traditional methods have created an opportunity for development of an end-to-end (E2E) learning approach for autonomous driving. E2E autonomous driving typically consists of a single, self-contained deep learning model that maps sensory input, such as image frames from a camera or maps generated by light detection and ranging (LiDAR), to steering wheel and accelerator actuation for vehicle control. E2E autonomous driving systems and methods can be configured to learn via reinforcement learning approaches, such as imitation learning, rather than depending on an aggregation of manually designed tasks. Successful training of an E2E autonomous driving approach using imitation learning must be capable of overcoming certain challenges such as the varying quality of human agent driving actions, the difficult of validating and testing the E2E model, scalability, and achievement of regulatory safety standards.

Despite regulatory hurdles, supply chain feasibility, and consumer skepticism of fully autonomous driving, development of improved semi-autonomous ADAS technology is ongoing. The advantages of E2E autonomous driving approaches are readily translatable to semi-autonomous driving approaches. It is accordingly desirable to employ ADAS technology that is compatible with increasing automation of driving tasks without extensive changes to hardware or software components. An opportunity arises for collision avoidance systems (CAS) and other ADAS features that leverage an E2E neural network configured for autonomous driving tasks.

### SUMMARY

The technology disclosed involves a system and methods for providing driver assistance alerts to a driver. The technology disclosed can include receiving environmental data for a sequence of driving states including at least video from a camera, returns from an optical sensor, and location data from a GNSS receiver. The camera, the optical sensor, and the GNSS receiver are coupled to a processor carried by a vehicle. The technology includes processing the environmental data as input to an end-to-end neural network, training an end-to-end neural network to generate prescriptive steering and speed control actions in response to a present driving state. It can extend to analyzing hidden layer data and output data from the end-to-end neural network to estimate collision avoidance data. This real time collision avoidance data includes, at least, one or more detected objects within the video from the camera, a directional cue, and a risk metric based at least in part on dissimilarity between the generated prescriptive steering and speed control actions and received driver steering and speed control actions. The directional cue can be projected onto a heads-up display. Other driver assistance alerts also can be generated in real time based on the collision avoidance data.

Particular aspects of the technology disclosed are described in the claims, specification and drawings.

### BRIEF DESCRIPTION OF THE DRAWINGS

This patent or application file contains at least one drawing executed in color and at least one photograph. Copies of this patent or patent application publication with color drawings and photographs will be provided by the Office upon request and payment of the necessary fee.

The color drawings and photographs also may be available in Patent Center via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is an architectural-level schematic of an end-to-end conditional imitation learning model for autonomous driving.

FIG. 2 illustrates an example of a plurality of possible driving states within a trajectory, in accordance with certain implementations of the present disclosure.

FIG. 3 is an architectural-level schematic of an end-to-end conditional learning model for autonomous driving comprising a memory-augmented transformer, in accordance with certain implementations of the present disclosure.

FIG. 4 is a flow chart describing a process for determining when to engage autonomous control of a vehicle in response to a high-risk driving scenario.

FIG. 5 is a schematic diagram showing the generation of collision avoidance data from the prescriptive outputs of an end-to-end autonomous driving model, in accordance with certain implementations of the present disclosure.

FIGS. 6A-D show a first example graphical user interface for a collision avoidance system.

FIGS. 7A-D show a second example graphical user interface for a collision avoidance system.

FIG. 8 illustrates a computer system that can be used to implement the technology disclosed, in accordance with certain implementations of the present disclosure.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Researchers across academia, government, and industry have long focused on developing semiautonomous and autonomous driving technology. The pursuit of machine automation traces back into pre-automobile history, evidenced by examples such as watermills, windmills, and Leonardo da Vinci's self-propelled cart. In response to the development of automobiles, fanciful notions of self-driving vehicles followed. Advancements in robotics, cameras and sensors, network infrastructures, and artificial intelligence (AI) have propelled the evolution of autonomous and semiautonomous driving technologies, including so-called advanced driver assistance systems (ADAS).

Modern vehicles frequently incorporate ADAS features like collision avoidance systems (CAS), lane keeping, and dynamic cruise control. ADAS features increase accessibility, particularly for seniors and individuals with mobility and sensory disabilities. Improvement and increased adoption of ADAS may alleviate several sources of traffic congestion, such as sub-optimal driving behaviors and collisions blocking the roadway. Furthermore, ADAS technology offers a clear safety advantage. The World Health Organization estimates that approximately 1.35 million people lose their lives in automobile accidents and the U.S. National Highway Traffic Safety Administration reports that up to 94% of serious accidents are attributable to user error.

Despite the rapid advancement of ADAS, challenges persist, including scalability for the training and validation of AI-based ADAS, cost efficiency, and feasibility of implementation. Traditional ADAS features fully or partially automate driving tasks using highly specialized components working cooperatively within complex systems. AI augmented ADAS can outperform earlier practices that rely on simpler algorithms like bang-bang controllers. However, AI-based approaches require massive volumes of training data, which is expensive and time-consuming to obtain. Many of the training techniques that show promise for improving the practicality and accuracy of ADAS remain in early-stage development, such as semantic segmentation in computer vision.

Emerging E2E learning approaches offer scalable and efficient alternatives for AI-based ADAS systems. E2E autonomous driving is understood in the art to include a singular system, such as a deep learning classifier, that is configured to automatically process sensory inputs, such as camera images, and generate actions that control vehicle actuators such as steering and acceleration/braking. For further information regarding the training and validation of E2E deep learning models configured for autonomous driving, reference can be made to the commonly owned US Patent Applications referenced above in the Related Applications section.

The proposed E2E approach to ADAS will be advantageous in its potential for seamless integration into increasingly autonomous functionality without for inconvenient and expensive updates to existing sensor hardware.

The technology disclosed provides a system and methods for providing both active and passive ADAS to drivers. An E2E driving model may be used for fully autonomous driving or, alternatively, as active, standby ADAS features. While a driver retains control of a vehicle, the E2E driving model operates in shadow mode until an imminent risk is detected. The E2E driving model automatically takes over to mitigate risk (e.g., collision avoidance).

E2E driving models may also be used for passive ADAS. Whereas active ADAS features override or correct a driver's actions, passive ADAS features can assist the driver in making safer decisions. The technology disclosed includes the presentation of driver alerts and warnings informed by the prescriptive outputs of an E2E driving model operating in shadow mode. In various implementations, one or more of the following can be communicated to the driver to help inform driving decisions: the prescriptive outputs from the E2E driving model, proximal objects detected by the E2E driving model, and/or directional cues indicating a recommended steering wheel orientation to avoid road hazards or follow an intended route. The driver alerts can include visual, auditory, and haptic alerts. Many implementations of the technology disclosed include a heads-up display that presents driver alerts without the driver needing to look away from the road. One form of display can be a heat map of objects identified as important by the E2E driving model projected onto the display. Another is directional cues for steering guidance, which can be presented on the display as dynamic “whisker” arrows representing respective current and/or recommended steering wheel orientation. An estimated risk level for the current driving actions can also be visually displayed to the driver. The passive ADAS alerts can also be used for driver feedback or driver education based on the prescriptive outputs and the driver's behavior.

### End-to-End Imitation Learning Model for Autonomous Driving

Despite the resources, funding, and public interest focused on the development of autonomous fleet vehicles, fully-autonomous driving technology is yet to exist in a format that meets safety and feasibility requirements for deployment to households. Technical advancements have resulted in a range of semi-automated driving technology achievements. These achievements possess varying accuracy and reliability, such as the safety features for lane-assist and collision-prevention systems that have become commonplace in modern vehicles and controversial semi-automated driving functions that allow a driver to partially relinquish steering and acceleration decisions to their vehicle. Autonomous driving technology still faces considerable barriers, however, in the areas of scalability and safety. As defined by the SAE, the extent of driving automation applicable to vehicles are:
Level 0—No automation and fully-manually controlled by a human
Level 1—Vehicle features a single automated system, such as a cruise control function
Level 2—Partial automation by advanced driver assistance systems for tasks such as steering and acceleration, wherein partially-automated tasks are fully monitored by the driver, who may intervene at any time
Level 3—Conditional automation engaged in response to appropriate environmental factor detection, with some human override involved
Level 4—High automation level characterized by full driving automation that a driver can still override when necessary
Level 5—Full autonomous control of the vehicle under all conditions with zero human control involved

While rare examples exist of Level 3 and Level 4 autonomous vehicles, mainstream production for consumer use has not surpassed Level 2 at the time of this disclosure. Further advancements in safety and reliability must be demonstrated to further progress. Safety standards applied to the functionality and performance of autonomous vehicles are primarily directed by the American National Standards Institute (ANSI) and ISO standards from the International Organization for Standardization.

Evaluation of autonomous products, including vehicles, utilizes the ANSI/UL 4600 standard for safety. ANSI/UL 4600, the first widely-adopted safety standard applied towards autonomous vehicle operation, evaluates fully autonomous products operating independently of human supervision. ANSI/UL 4600 establishes broad, technology neutral guidelines for safety in terms of risk analysis, data integrity, autonomy validation, life cycle resiliency, and conformance assessment. In contrast, ISO standards such as ISO 26262, ISO 21488, and ISO/SAE 21434 define requirements specific to autonomous vehicle technology safety. ISO 26262 evaluates functional safety of electrical/electronic systems in vehicles, particularly safety management in the event of a system malfunction or failure. ISO 21488 covers the safety of the intended functionality (SOTIF), which addresses unintended behavior of systems in absence of an ISO 26262 system malfunction. ISO/SAE 21434 covers cybersecurity risk management at stages ranging from concept design, development and manufacturing processes, operation, maintenance, and decommissioning of road vehicles.

A primary obstacle blocking the satisfactory compliance of autonomous vehicles to the above-described safety standards is scaling. For an autonomous vehicle to be adequately safe, reliable, and generalizable to complex and dynamic driving landscapes, a massive volume of data is necessary. While data availability limitations are not exclusively responsible for all remaining technical gaps, data need is intimately connected to all aspects of autonomous driving system development. Areas of technology under improvement that are related to autonomous vehicles, for instance, computer vision and sensor development, are limited in their growth potential without available data to learn from that is sufficient in both magnitude and variety. Moreover, additional technical scalability dilemmas related to time, cost, and resources cannot be addressed without the information at hand to do so.

Both traditional autonomous driving technologies and end-to-end learning approaches rely heavily on artificial intelligence and deep learning systems that evaluate the environment, predict future changes to the environment, and make decisions in response to the environment. The development of robust, generalizable deep learning models capable of learning complex feature spaces and patterns is highly dependent on rich data for training, validation, fine-tuning, and further evaluation/testing processes.

The autonomous driving systems and methods described in the present disclosure address this issue using an E2E approach. The E2E architecture of the disclosed systems improves scalability by reducing the dependency on up-to-date, highly complex map data and is configured to process driving conditions not previously seen during training. Using E2E approaches is substantially more efficient in terms of data usage and computational cost, in part, due to the configuration of the deep learning model to extract useful features directly from input data and converting input data processing directly into driving actuation.

However, scalability concerns are not fully addressed by the improvements offered by implementing an E2E approach. It is still necessary to acquire enough data for both learning and validation processes that provides sufficient training for rare and difficult scenarios. Corner cases such as extreme weather, close proximity to collisions, and spontaneous road blockages by pedestrians or stray objects are rare occurrences that are difficult to obtain sufficient amounts of training data for, but these scenarios are also crucial for autonomous driving models to learn due to their significant safety risk and potential consequence if handled poorly. In addition to the obvious ethical importance, safety standards such as the SOTIF guidelines within ISO 21448 substantially focus on the evaluation of risk level in response to hazardous events.

In contrast to corner cases, which generally refer to rare and potentially hazardous driving scenarios, care must also be taken to ensure that a model is sufficiently capable of handling edge cases. Edge cases, although frequently overlapping with corner cases, address conditions that may introduce unique challenges to computational systems as compared to human drivers. Autonomous vehicles may respond poorly to edge cases, for example, due to limitations in computer vision technology or highly-individualized scenarios. While situations like heavy rain or a busy elementary school child pick-up lane can often be stressful or challenging for a human driver, the complexity is intensified for an autonomous driving model that may not be able to generalize from simple driving to routinely encountered stressful situations

The difficulty of training an autonomous driving model that is not only familiar with an adequately diverse range of driving scenarios, but also generalizable to scenarios that are unfamiliar, can be addressed using reinforcement learning and imitation learning approaches. By leveraging driving demonstrations performed by human drivers, it is possible to train an autonomous driving model, like the E2E system disclosed herein, to learn feature distributions, feature patterns, and overall behavioral policy, therefore enabling the model to process driving scenarios and determine a plan of best action in response to input data from the environment that does not depend on previous exposure specific to the scenario, location, or route.

Further detail on how the disclosed systems and methods can provide a solution to scalability and performance challenges by combining the advantages of E2E learning and imitation learning strategies with additional deep learning methodology that enables context-aware learning and scalable approaches for data collection, training, and validation, reference can be made to the commonly owned US Patent Applications listed above under Related Applications. Next, the architecture of the disclosed E2E model is discussed in further detail.

### System Architecture

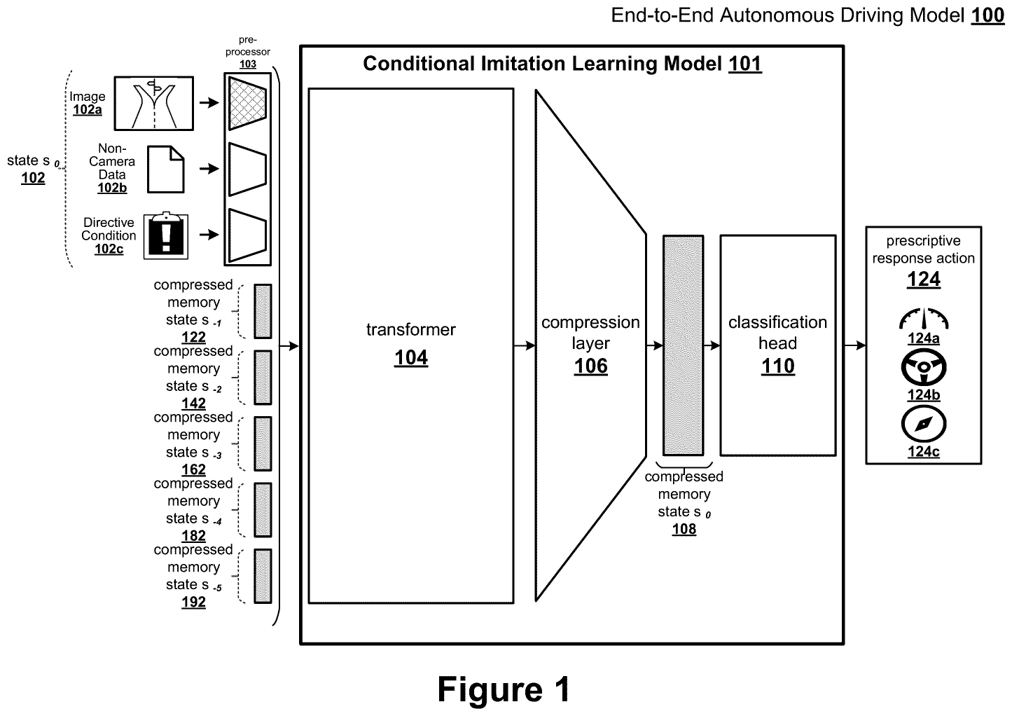

FIG. 1 is an architectural-level schematic 100 of an end-to-end conditional imitation learning model 101 for autonomous driving. Conditional imitation learning model 101 is illustrated within schematic 100 in accordance with one exemplary implementation of the technology disclosed comprising a transformer architecture. At a high level, the conditional imitation learning model 101 processes environmental data corresponding to a state s₀ 102 within a driving environment to prescribe an appropriate response action 124. The prescriptive response action can include actuation of the steering wheel and accelerator/brakes that change the speed 124a, orientation 124b, and thus, location 124c of the vehicle.

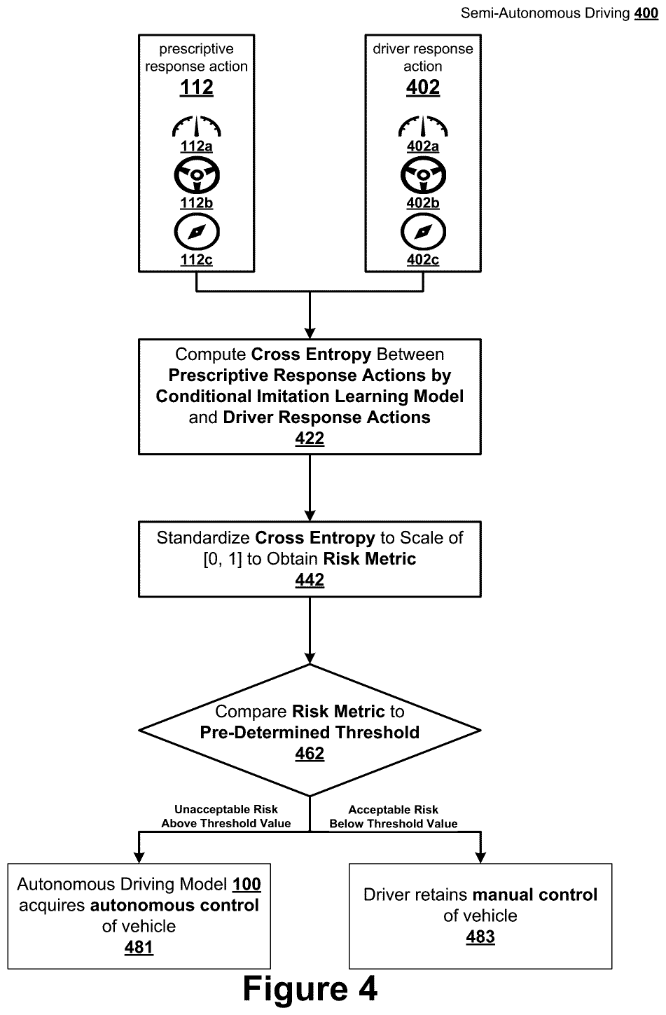

In a fully autonomous driving mode, the prescriptive response action 124 is executed via operation of one or more actuators controlling a vehicle. In a semi-autonomous mode, the conditional imitation learning model 101 is operating in a so-called “shadow mode”. A human driver manually operates the vehicle while conditional imitation learning model 101 is operating in the background and generating outputs without actuation of the brakes, steering wheel, etc. as directed by the prescriptive response action 124. The prescriptive response action 124 is used to inform one or more ADAS functionalities of the vehicle. For example, a passive ADAS tool may leverage the conditional imitation learning model 101 for CAS purposes by alerting the driver to brake when the prescriptive response action 124 calls for brake actuation, thereby mitigating the risk of an imminent collision with another object. An active ADAS tool may leverage the conditional imitation learning model 101 for CAS purposes by executing autonomous braking when the prescriptive response action 124. This brake actuation mitigates the risk of an imminent collision with another object. The use of conditional imitation learning model 101 for collision avoidance is expanded upon further with reference to FIG. 4. The input data and architecture of conditional imitation learning model 101 will now be described in further detail.

Input state s₀ 102 is represented by observations including an image 102a and a plurality of non-camera environmental data 202b (e.g., LiDAR and GNSS data). In addition to the observations describing state s₀ 102, a directive condition 102c (e.g., a GPS-direction guiding a vehicle along an intended route) is also provided in certain implementations. Hence, conditional imitation learning model 101 predicts an action (e.g., braking) in response to a state (e.g., rapidly approaching the rear of another vehicle). In another implementation, the conditional imitation learning model 101 predicts an action (e.g., steering the vehicle to the right) in response to a state (e.g., approaching an intersection with another perpendicular street) including a directive condition (e.g., a route directive to turn right onto the perpendicular street to stay on the navigation route). A conditional route may refer to a route directing the vehicle to a specific target end location, or a shorter-term conditional route such as the next three, five, or ten seconds of the driving routes. In some implementations, the route is based on a static target end location. In other implementations, the target end location may be dynamic and shift in response to previous route progress.

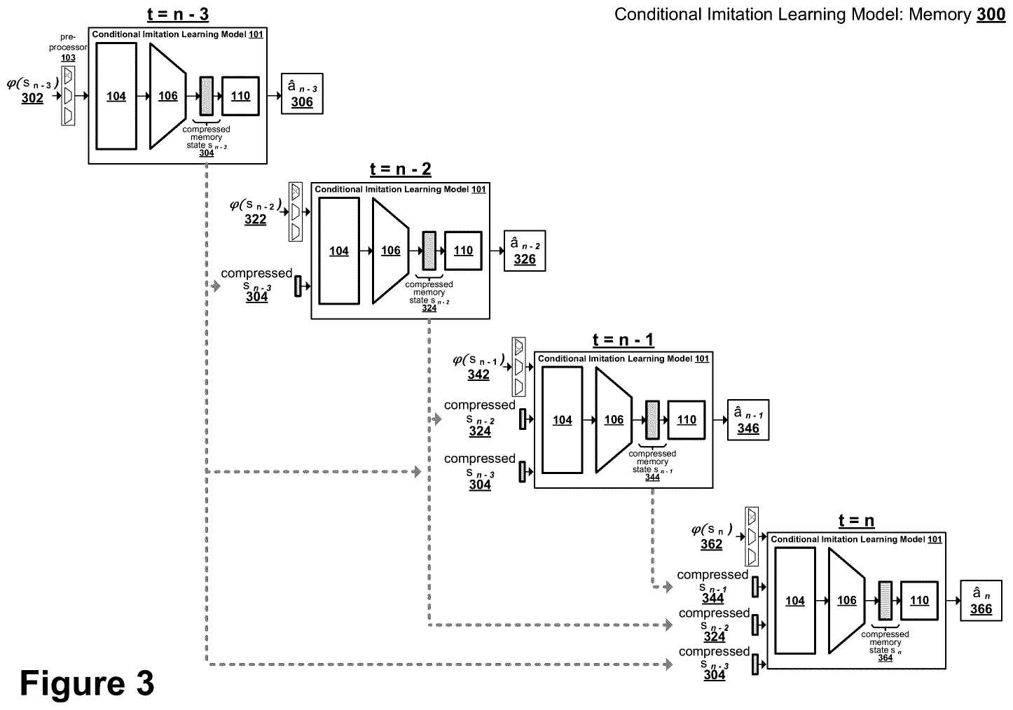

In addition to the data corresponding to the present state s₀ 102, memory data in a compressed format is extracted from storage in a frame buffer containing information corresponding to a number of prior states in the given trajectory. For simplicity and clarity, schematic 100 illustrates a total of five previous memory frames-compressed memory state s₋₁ 122, compressed memory state s₋₂ 142, compressed memory state s₋₃ 162, compressed memory state s₋₄ 182, and compressed memory state s₋₅ 192. However, in many implementations of the technology, more than five previous memory frames are stored in the frame buffer for use as input to the present state such as ten, fifteen, twenty or a larger number of previous memory frames. These memory frames may cover two, three, five or more seconds of history at frame rate lower than standard video capture. A memory frame refers to a “snapshot” or latent representation of previous states processed by conditional imitation learning model 101. The generation and storage of compressed memory states into the frame buffer is elaborated upon further later in the discussion of the transformer architecture with respect to FIG. 3. As previously described, the segmentation of driving state data into states within a trajectory is variable. In certain implementations of the technology disclosed, the number of states corresponds to at least three seconds of history preceding the present state s₀ 102.

Prior to the second processing stage performed by conditional imitation learning model 101, observation data for state s₀ 102 undergoes pre-processing in a first stage processor stage by pre-processor module 103. Pre-processor 103 embeds the respective input data from image 102a, non-camera environmental data 102b, and directive condition 102c. In some implementations, image 102a undergoes image processing that is unique to the deep learning analysis of image data, as indicated by the hashed-line shading of the unit within pre-processor 103 adjacent to image 102a. In certain implementations, this image processing is performed by a convolutional neural network. In one implementation, the processing model responsible for pre-processing data contained in image 102a is a pre-trained module that has been transferred or fine-tuned for use in conjunction with conditional imitation learning model 101. In some implementations, the pre-processing of image 102a, or other spatial mapping data (e.g., LiDAR data), involves generation of positional embeddings that maintains the integrity of the location information corresponding to the data. In one implementation, the positional embedding data can later be used to construct a heat map, like an attention map using the attention weights from conditional imitation learning model 101, for object detection purposes to inform CAS operations. For example, using positional embeddings from image data 102a and attention weights from transformer 104 to construct an attention map can enable the detection of a region within the camera view that was considered important by conditional imitation learning model 101 in generating a prescriptive output action 124 including brake actuation. When the attention map is projected back onto the image data 102a, the important region could overlap with a pedestrian walking in a crosswalk or another vehicle ahead. Terms relating to the “importance” of an input feature or token or the “attention” towards that input feature or token are terms of art that will be readily recognized by a skilled user.

After pre-processing, the processing stack, comprising conditional imitation learning model 101, processes the embedded outputs from pre-processor 103 along with the compressed memory states 122, 142, 162, 182, and 192 using a transformer 104 and compression layer 106. The compression layer 106 of the illustrated processing stack produces the memory frame for input state s₀ 102. In other words, the output of compression layer 106 is a compressed memory state 108 of input state s₀ 102. Compressed memory state s₀ 108 will be stored within the frame buffer using a FIFO (first in, first out) storage process such that at the time of processing a state s₁, the frame buffer will include compressed memory representations 108, 122, 142, 162, and 182 respective to states s₀, s₋₁, s₋₂, s₋₃, and s₋₄.

To generate the predicted response action 124 in response to input state s₀ 102, compressed memory state s₀ 108 is processed in the third stage processor by a classification head 110 to generate the prescriptive response action 124. Specifically, the compressed memory states₀ 108 is processed to produce actuation of the steering wheel and accelerator/brakes that can change the speed 124a, orientation 124b, and thus, location 124c of the vehicle.

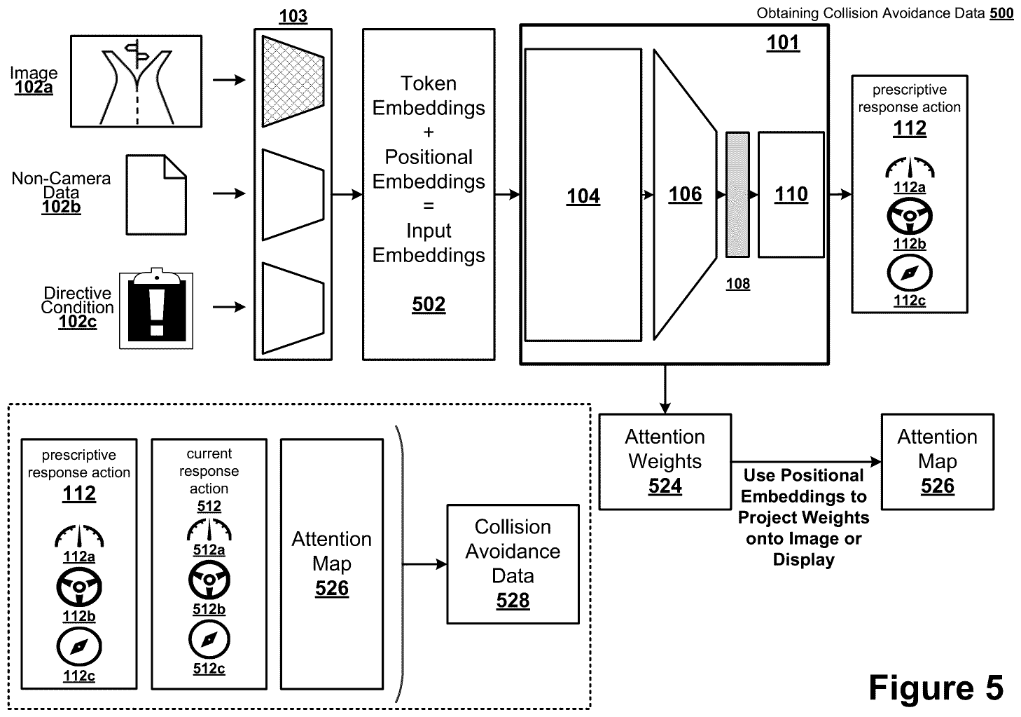

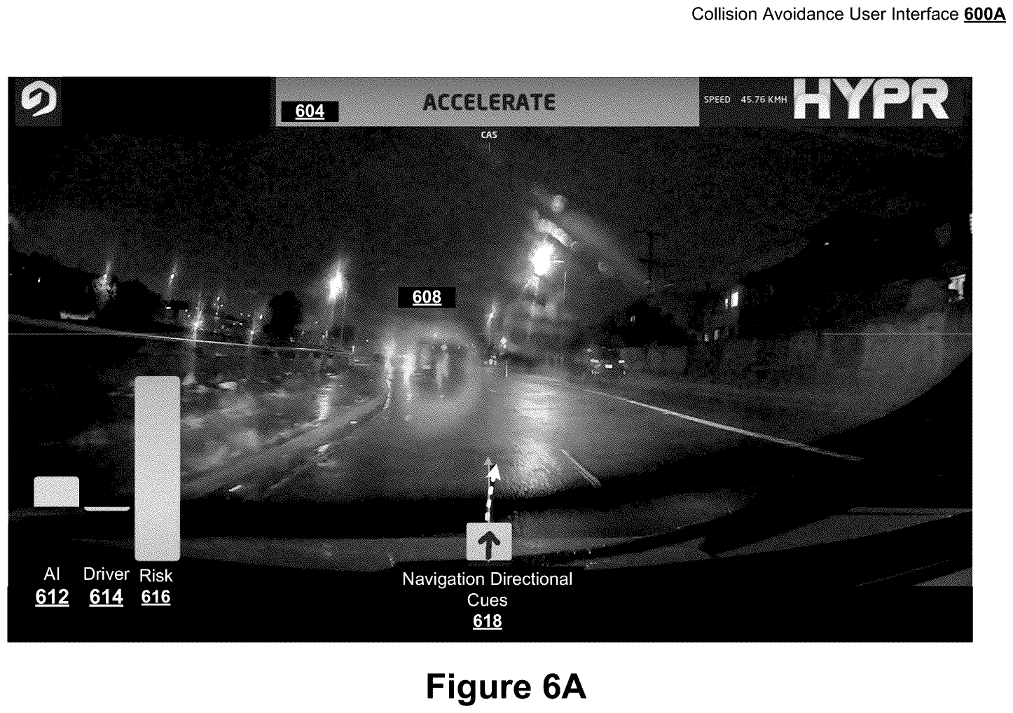

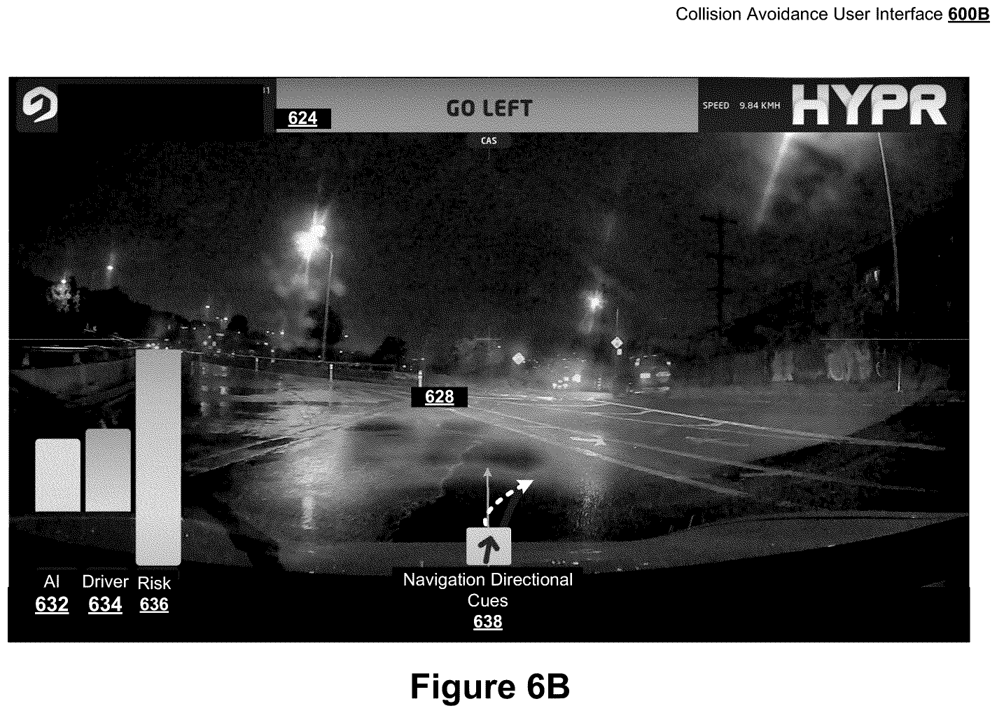

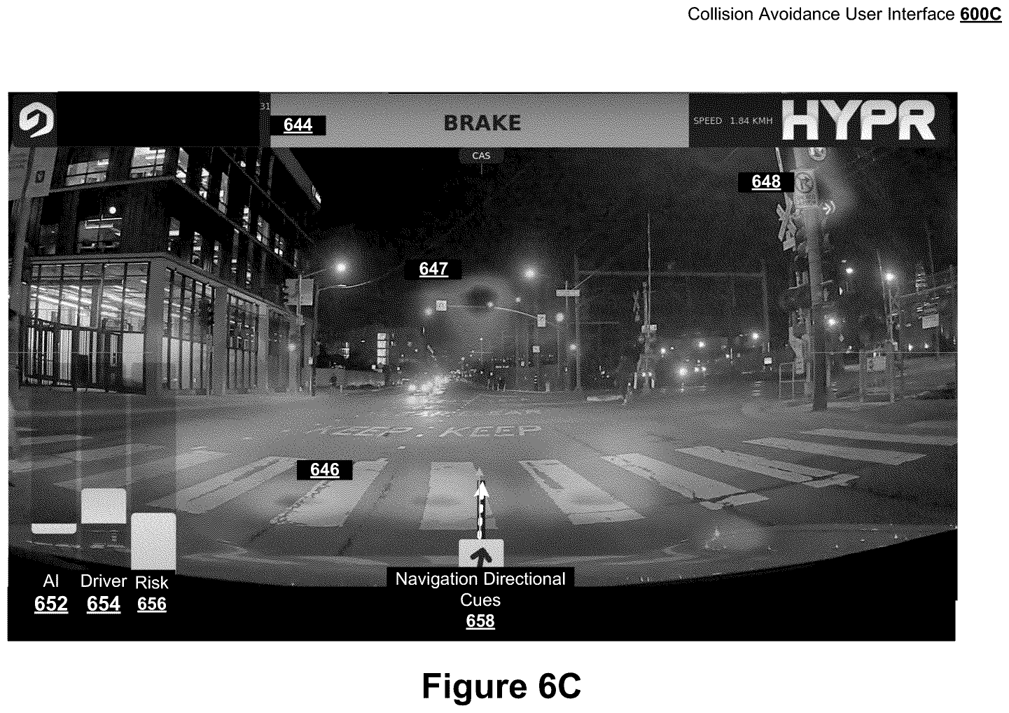

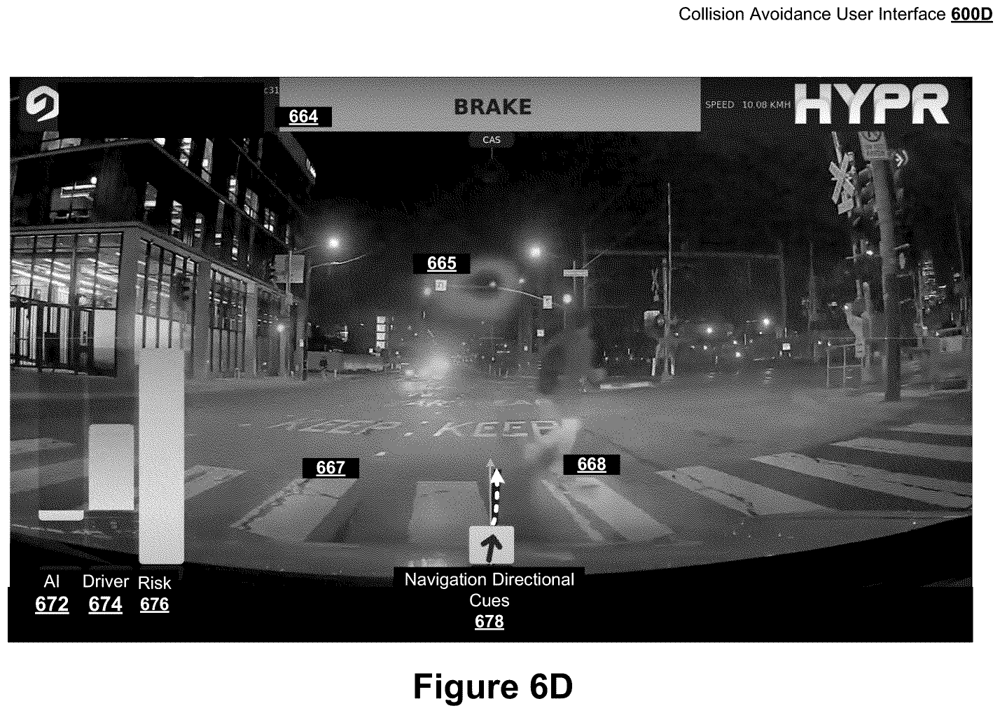

The conditional imitation learning model 101 is an end-to-end autonomous driving model that can be employed for total automation of vehicle operation by executing prescriptive response action(s) 124. Additionally, driving automation by conditional imitation learning model 101 can be translated into partial automation of vehicle operation, e.g., Level 2 or Level 3 automation tasks. As introduced above, conditional imitation learning model 101 can operate within a shadow mode. When conditional imitation learning model 101 operates within a shadow mode, the prescriptive response action 124 is made available for ADAS use. In passive ADAS, driver assistance alerts and warnings can be generated based on the prescriptive response action 124. In active ADAS, task automation can involve executing prescriptive response action 124. In one implementation, prescriptive response action 124 is processed to compute a risk level associated with a current driving state to inform the decision of whether manual or autonomous driving is more appropriate. Various implementations involving passive ADAS, active ADAS, and risk calculation are expanded upon further with reference to FIGS. 4 and 5, and example use cases are presented in FIGS. 6A-D and 7A-D.

To establish a foundation in accordance with certain implementations of the system and methods disclosed herein, a deep learning framework will now be described in further detail. The disclosed conditional imitation learning model 101 is an end-to-end autonomous driving model using imitation learning and memory augmentation techniques to mimic the driving behavior of a skilled, safe human driver. Imitation learning and memory augmentation will be briefly introduced below. For an in-depth description of the systems and methods used for scalable training and validation of an end-to-end autonomous driving model, such as conditional imitation learning model, reference can be made to commonly owned US Patent Applications referenced in the Related Applications section, above.

First, a high-level introduction is provided for imitation learning concepts relating to state-action pairs within a driving trajectory and driving behavioral policies learned from driving trajectories. Next, the discussion turns to the disclosed memory-augmented transformer. A memory-augmented transformer enables generation of a prescriptive action in response to a state including the processing of previous states in the trajectory, in contrast to the processing of instantaneous state data lacking information from the recent past that provides useful context for driving decisions.

### Imitation Learning for Autonomous Driving

Conditional imitation learning model 101 is trained using a large database of driving demonstrations in order to estimate a driving behavioral policy. A driving demonstration can include one or more driving tasks such as lane merging, handling a four-way stop, and sudden braking in response to an imminent collision risk. The driving tasks within a driving demonstration may be performed within a variety of environmental conditions, including varying times of day, weather conditions, types of roads and highways, and degrees of traffic. Driving demonstrations may be collected from a fleet of vehicles operated manually by human drivers, autonomous vehicles, or driving simulation. Driving demonstrations are explained in further detail with reference to FIG. 3 below the subsequent discussion of model training approaches of an imitation learning model for autonomous driving.

Conditional imitation learning model 101 learns, from the training driving demonstrations, a driving behavioral policy. The driving behavioral policy is a probability distribution over actions given states, also referred to as a mapping of states to actions. A driving behavioral policy imitates the subjective rules and logic that a human applies to driving. A trained imitation learning model uses the estimated behavioral policy, embodied in model coefficients, to compute a prescribed action, such as braking, in response to a state, such as a red light in video input. An imitation estimation of such a policy from a large training data set (e.g., hundreds of thousands or millions of examples) inevitably performs better than a list of driving rules would. Moreover, a list of driving rules that would be sufficiently comprehensive would need to be infeasibly long and complex. In contrast, estimation of a behavioral policy using an imitation learning model is better equipped to extract such complexities from driving demonstration examples.

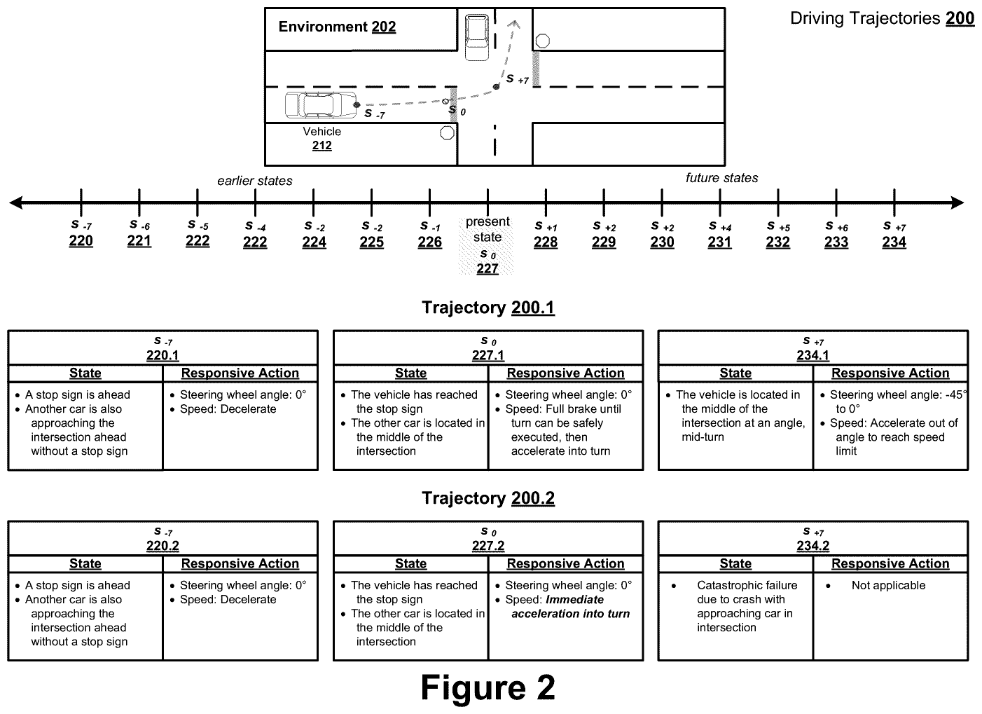

A well-trained imitation learning model trained on a large number of driving demonstrations is generalizable to a broad range of driving states and environmental stimuli, both seen and unseen to the model during training, because the model has learned an underlying rationale for driving decisions rather than memorizing specific actions to perform in response to specific states. The disclosed conditional imitation learning model 101, as implied by the title, is trained to predict an action in response to a state, based on a condition restricting the vehicle's driving trajectory. For example, an autonomous vehicle may need to turn left at an intersection in order to stay on an intended route (the condition restricting the vehicle's driving trajectory). According to the learned behavioral policy estimated by the trained conditional imitation learning model 101, the autonomous vehicle knows to yield to oncoming traffic before executing the left turn. Furthermore, if the road conditions are icy at the time, the autonomous vehicle will adjust rates of deceleration and acceleration during the turn accordingly, as informed by the learned behavioral policy. Terminology like “action”, “state”, “trajectory”, and “environment” will be used herein according to their meaning as understood within the field of conditional imitation learning in contrast to other common meanings. The description with reference to FIG. 2 below further elaborates on conditional imitation learning terminology.

FIG. 2 illustrates an example 200 of a plurality of possible driving states within a trajectory, in accordance with certain implementations of the present disclosure. Example 200 occurs within the context of a driving environment 202. The driving environment 202 includes a particular layout of roadways with various orientations and relevant legal guidelines for use of the roadways, structures and objects surrounding the roadways, weather and atmospheric conditions, other vehicles, pedestrians, and a vehicle 212. A user skilled in the art will recognize that a driving trajectory, or simply trajectory, refers to the driving route of vehicle 212. A large, near infinite number of possible trajectories exist within environment 202 equivalent to the total combination and permutation of possible routes that can be taken within the environment, each of which has the potential to be very long. The actualized trajectory taken by vehicle 212 can be described by a sequence of states, represented by the illustrated number line.

The illustrated number line centers on a present state s₀ 227. Present state s₀ 227 was preceded by a sequence of earlier states including state s₋₁ 226, state s₋₂ 225, state s₋₃ 224, state s₋₄ 223, state s₋₅ 222, state s₋₆ 221, and state s₋₇ 220. Present state s₀ 227 will be succeeded by a sequence of future states including state s₊₁ 228, state s₊₂ 229, state s₊₃ 230, state s₊₄ 231, state s₊₅ 232, state s₊₆ 233, and state s₊₇ 234. The trajectory of vehicle 212 is also illustrated within the schematic of environment 202 by the grey, dashed arrow indicating that vehicle 212 indicates to turn left at the approaching intersection. As shown within the schematic of environment 202, vehicle 212 is approaching a stop sign at state s₋₇ 220 and reaches the stop sign at the present state s₀ 227. If the future states are carried out as intended, vehicle will be mid-execution of a left turn and positioned in the middle of the illustrated intersection at state s₊₇ 234.

While vehicle 212 encounters a stop sign at the present state s₀ 227, vehicles traveling across the illustrated intersection along the cross-street do not have a stop sign and may drive straight through. As a result, vehicle 212 is expected to abide by the stop sign and reach a complete stop at the present state s₀ 227, yield to crossing vehicles and remain fully stopped at the stop sign until there is sufficient clearance to safely initiate the left turn to avoid a collision with a crossing vehicle.

Two trajectories are described within example 200, trajectory 200.1 and trajectory 200.2. Trajectory 200.1 is described with reference to three representative driving states within the trajectory, including earlier state s₋₇ 220.1, the present state s₀ 227.1, and a future state s₊₇ 234.1. Within each driving trajectory, each state sₙ, occurring at a time tₙ, can be described by a plurality of features associated with the vehicle and/or the surrounding driving environment at time tₙ. This data is collected by hardware coupled to the vehicle, such as one or more cameras and/or LiDAR sensors. For example, at state s₋₇ 220.1, sensors coupled to vehicle 212 record environmental data within environment 202, such as the stop sign ahead and another vehicle approaching the intersection via the cross-street.

A responsive action an can be executed in response to each state sₙ. In response to state s₋₇ 220.1, the operator does not execute any actions that change the steering wheel angle from the neutral position of 0° but braking is engaged in order to comply appropriately with the stop sign. For convenience and clarity, steering wheel orientation will be described in reference to angular measurements where 0° indicates that the vehicle is driving straight ahead, positive angles like +45° indicate steering towards the right, and negative angles like −45° indicate steering towards the left. In certain implementations, training data will further include information about the operator's eye movements using retinal tracking data.

At the present state s₀ 227.1 of trajectory 200.1, vehicle 212 has approached the boundary indicating the appropriate position to stop in compliance with the stop sign. At state s₀ 227.1, the sensors coupled to vehicle 212 indicate that the vehicle has reached the stop sign and the crossing vehicle is now directly in front of vehicle 212 as it crosses the intersection along the cross street. As a result, the operator of vehicle 212 the operator does not execute any actions to change the speed or steering orientation of the vehicle. When vehicle 212 reaches future state s₊₇ 234.1, the sensors coupled to vehicle 212 indicate that the vehicle is now located within the intersection while executing its turn. In response to state s₊₇ 234.1, the operator executes action a₊₇ including turning the steering wheel to the left at an appropriate angle, such as −45°, and acceleration out of the turn to return to the normal speed limit once vehicle 212 completes its turn.

Driving trajectory 200.1 represents a safe series of state-action pairs that is appropriate for the given driving task, but many other trajectories are possible within environment 202. Furthermore, trajectories are not pre-destined. As a first state sₜ transitions into a new state sₜ₊₁, there exists a set of the total number of actions possible in response to state sₜ₊₁. The selection of an action is a variable in the determination of the state transition and resulting state sₜ₊₂. Many implementations of the technology disclosed include using an estimated behavioral policy learned by conditional imitation learning model 101 to generate a prescribed action in response to a state, and execution of the prescribed action will naturally influence the characteristics of subsequent states. Accordingly, two different trajectories are not guaranteed to continue overlapping solely because they began with overlapping states and actions. As an extension, it is possible for trajectories to converge or diverge from one another at any state or any point in time. To aid in illustrating transitions from one driving state to the next, as well as the relationship between an executed action and the resulting state transition, a second trajectory 200.2 is also provided in example 200.

Trajectory 200.2 represents a unsafe, catastrophic series of state-action pairs. It is described with reference to three representative driving states within the trajectory, including earlier state s₋₇ 220.2, the present state s₀ 227.2, and a future state s₊₇ 234.1. At state s₋₇ 220.2, the state and action are the same as those within state s₋₇ 220.1 in trajectory 200.1, so the details will not be stated redundantly here. However, trajectory 200.2 diverges from trajectory 200.1 at state s₀ 227.2. The operator does not comply with the stop sign at state s₀ 227.2 and does not wait for the crossing vehicle to safely clear the intersection prior to executing their turn. Instead, the executed action by the operator in response to state s₀ 327.2 includes initiating the left turn without stopping.

Consequently, the vehicle 212 collides with the crossing vehicle within the intersection at some point following state s₀ 227.2, resulting in catastrophic failure that prematurely ends the trajectory. Because the trajectory ended at the collision incident, trajectory 200.2 will not reach a future state s₊₇ 234.2.

Actions resulting in catastrophic failure are not the only cause of divergence between different trajectories. Within example 200, both trajectories share the same intended route, driving task, and share the same goal, and differ only in their quality and success of execution. Two previously overlapping driving trajectories may diverge at a driving state where one driver turns left and the other turns right.

In one implementation of the technology disclosed, conditional imitation learning model 101 may be trained to clone the behavior of the operator within trajectory 200.1 with the goal of successfully emulating the safe driving techniques demonstrated by the operator of vehicle 212. In another implementation, conditional imitation learning model 101 is trained with reinforcement learning methods using trajectory 200.1 as a positive example, wherein similarity to the actions within trajectory 300.1 is rewarded, and using trajectory 200.2 as a negative example, wherein similarity to the actions within trajectory 200.1 is penalized. Other alternative training approaches can also lead to conditional imitation learning model 101 successfully learning the turning safety behavior demonstrated by example 200.

Conditional imitation learning model 101 is trained on driving demonstrations, like the trajectories shown in example 200 as well as more complex scenarios, to learn a behavioral policy that can be applied to environmental data 102a, 102b and condition 102c corresponding to a present driving state s₀ 102 and generate a prescriptive response action a₀ 124, at which point the trajectory transitions to a subsequent driving state s₁.

Given the influential and lasting effects previous states and actions have on the future state of a trajectory, there is considerable benefit to modeling the local and global dependencies between trajectory states when predicting driving behaviors. Hence, autonomous driving models are at a disadvantage if they are not able to store any previous information in a memory cache or retrieve that information for contextually-aware decision making. Deep learning architectures configured to achieve memory-informed prediction, such as recursive neural networks or multi-headed attention mechanisms for transformer models, are frequently computationally expensive. Given the complexity of autonomous driving problems, recursive neural networks or multi-headed transformers are likely to operate slower than desired. In some implementations of the technology disclosed, the complexity of the specific learning problem and/or the computational processing power available warrants the use of these models. However, in most cases, the associated time, monetary, and computing costs of these models can be quite prohibitive and may affect the capacity of the model to achieve safety standards, such as the SOTIF guidelines set forth in ISO standard 21448 as previously described.

The discussion now turns to the introduction of a memory-augmented transformer that leverages input augmentation with memory cached data to enable the use of local and global dependency patterns within driving trajectories with improved efficiency as compared to traditional recursive neural network or transformer models.

### Memory-Augmented Transformer

FIG. 3 is an architectural-level schematic 300 of an end-to-end conditional learning model 101 for autonomous driving comprising a memory-augmented transformer, in accordance with certain implementations of the present disclosure. Schematic 300 is equivalent to schematic 100, wherein the processing of four separate time steps is illustrated in a so-called unrolled state. In contrast to a multi-head transformer model that is configured to repetitively process large quantities of input data corresponding to a plurality of sequential states within a trajectory, the memory-augmented transformer illustrated within schematic 300 utilizes a first-in, first-out frame buffer that stores a cached memory state of previously processed states in the trajectory. Each frame, or memory state, within the frame buffer contains the compressed latent space representation of a respective earlier state generated by compression layer 106 of schematic 100. Given that the processing of a particular state sₜ by compression layer 106 to receive a corresponding compressed representation of state sₜ includes the processing of the n frames within the frame buffer for the earlier states {sₜ₋₁, . . . , sₜ₋ₙ}, assuming a constant frame buffer size, the predicted action âₜ in response to sₜ is generated in response to compressed data representing the earlier states {sₜ₋₁, . . . , sₜ₋₂ₙ}.

Schematic 300 begins with the processing of data at a timepoint t=n−3 and ends with the processing of a timepoint t=n. A set of observations for a state sₙ₋₃, φ(sₙ₋₃) 302, is assumed to be the earliest state to the processed in the trajectory, hence no frames are current stored within the frame buffer for timepoint t=n−3. Pre-processor 103 embeds data from φ(sₙ₋₃) 302, followed by processing by transformer 104 and the generation of a compressed memory state representation 304 of state sₙ₋₃ by compressor 106. The compressed memory state representation 304 of state sₙ₋₃ is processed by the classification head 110 to generate a predicted action âₙ₋₃ 306.

For timepoint t=n−2, the pre-processor 103 embeds data from φ(sₙ₋₂) 322. In addition to the embedded data from state sₙ₋₂, the frame buffer now stores a frame for the compressed memory state 304 of state sₙ₋₃. These combined inputs are processed by transformer 104 followed by compressor 106 for the generation of a compressed memory state representation 324 of state sₙ₋₂. The compressed memory state representation 324 of state sₙ₋₂ is processed by the classification head 110 to generate a predicted action âₙ₋₂ 326.

For timepoint t=n−1, the pre-processor 103 embeds data from φ(sₙ₋₁) 342. In addition to the embedded data from state sₙ₋₁, the frame buffer now stores a respective frame for both the compressed memory state 304 of state sₙ₋₃ and the compressed memory state representation 324 of state sₙ₋₂. These combined inputs are processed by transformer 104 followed by compressor 106 for the generation of a compressed memory state representation 344 of state sₙ₋₁. The compressed memory state representation 344 of state sₙ₋₁ is processed by the classification head 110 to generate a predicted action âₙ₋₁ 346.

For timepoint t=n, the pre-processor 103 embeds data from φ(sₙ) 362. In addition to the embedded data from state sₙ, the frame buffer now stores a respective frame for the compressed memory state 304 of state sₙ₋₃, the compressed memory state representation 324 of state sₙ₋₂, and the compressed memory state representation 344 of state sₙ₋₁. These combined inputs are processed by transformer 104 followed by compressor 106 for the generation of a compressed memory state representation 364 of state sₙ. The compressed memory state representation 364 of state sₙ is processed by the classification head 110 to generate a predicted action âₙ 366.

If the illustration were to show future timesteps of the memory-augmented transformer model, the frame buffer would eventually reach capacity and begin losing the oldest frame, one at a time per timestep, to make room for the storage of the most recent frame.

The prescriptive actions generated by conditional imitation learning model 101 are executed for controlling an autonomous vehicle. For a partially autonomous vehicle, conditional imitation learning model 101 may be operating in a shadow mode. While operating in shadow mode, the processes described with reference to FIGS. 1 and 3 are still performed, but the prescribed actions generated by the model are not automatically executed by the actuators of the vehicle. Instead, a human driver can retain manual control of the vehicle while the model-generated outputs are leveraged by ADAS to provide driver alerts.

Advanced Driver Assistance Systems with End-to-End AI

The disclosed conditional imitation learning model 101 may be used to implement additional advanced driver assistance systems within an autonomous or semi-autonomous vehicle. In certain implementations, an advanced driver assistance system configured to act as a collision avoidance system can be designed to emit a warning signal (an audible and/or visual notification) to a human agent operating a vehicle in response to a predicted dangerous driving state being detected. In one implementation, the detection of a potential danger by the conditional imitation learning model 101 (or a separate trained model that is associated with conditional imitation learning model 101) is performed in response to an interaction with the accelerator/brake actuator(s) that deviates from a prescribed speed. In another implementation, the detection of a potential danger by the conditional imitation learning model 101 (or a separate trained model that is associated with conditional imitation learning model 101) is performed in response to the processing of a feature of one or more driving states, such as an object detected in close-proximity or rapidly-approaching proximity to the vehicle, a changing traffic signal, or a lane deviation.

In some implementations, the advanced driver assistance systems configured via data collection, learning, and statistical analyses performed in association with the methods and systems disclosed herein may be implemented within a semi-autonomous vehicle to instigate the transition of manual control to autonomous control or vice-versa. In one example, an advanced driver assistance system, such a CAS response, may be configured to respond to a predicted collision (i.e., in response to an object in close proximity to the vehicle or a lack of response from an operator to a traffic signal) by overriding manual control of the vehicle and initiating automated breaking. In another example, a so-called “adaptive cruise control” system may be configured to respond to a vehicle exceeding a pre-defined allowable threshold for object proximity (e.g., a pre-defined distance allowed between the operator's vehicle and a separate vehicle directly in front of the operator's vehicle such as a minimum distance between vehicles of thirty feet, fifteen meters, or two car-lengths) or for speed (e.g., a pre-defined speed limit for the vehicle such as eighty miles-per-hour, seven miles-per-hour over the presently-detected speed limit, or a ten percent increase in speed over the presently-detected speed limit).

In a third example, the advanced driver assistance system may provide a range of statistical analyses performed on the driving behavior of the vehicle, independent of the extent to which the vehicle is autonomously-operated, towards the operator regarding the current performance and behavior of the vehicle that can be useful for the operator in terms of driving behavior, safety warnings and feedback, or potentially-necessary vehicle maintenance. This data that can be provided to the vehicle operator, such as a risk metric or suggested adjustments to driving behavior, can be more informative than typical driving data presented towards an operator in thanks to the high-dimensional, high-volume data collected by the conditional imitation learning model 101. Analyses may include data relating to how frequently the driver engages in high-risk behavior, speed and maneuverability trends (e.g., swerving, unsafe lane changes, etc.), frequency of near-collisions and/or events during which autonomous control was necessary to avoid collisions, and so on.

In the above-described example implementations, as well as a number of further scenarios to which a user skilled in the art would recognize an advanced driver assistance system could be implemented within the technology disclosed herein, an advanced driver assistance system may leverage driving demonstration data from both human agents and autonomous driving agents, as well as any associated analyses, used in training, validation, fine-tuning, or transfer learning. The advanced driver assistance system may also leverage pattern recognition and risk analysis data extracted from a trained autonomous driving model, as well as external data input by further expert feedback and/or computational analysis of data extracted from the trained autonomous driving model. Furthermore, the advanced driver assistance system may also leverage data and data analysis obtained from driving trajectories performed after initial model deployment. In operation, vehicles continue to collect and monitor data from an operator after deployment of the trained autonomous driving model. The data collected can be used both to corrective actions to the operator and to continue fine-tuning the model.

FIG. 4 is a flow chart describing a semi-autonomous process 400 for determining when to engage autonomous control of a vehicle in response to a high-risk driving scenario. Process 400 includes the comparison of collected data from conditional imitation learning model 101 operating in a shadow mode, including the model's prescriptive response actions 112, against manual driver response actions 402. In this semi-autonomous driving mode, the driver manually controls the vehicle by executing driver response actions 402 including speed control 402a, steering control 402b, and optionally, following directions according to a navigational route 402c. The conditional imitation learning model 101 is operating in a shadow mode such that prescriptive response actions 112 (e.g., speed control 112a, steering control 112b, and optionally, directions according to a navigational route 112c) are still generated, but are not always automatically executed. Prescriptive response actions 112 are leveraged to inform advanced driver assistance systems. FIG. 4 shows a process of active ADAS, including engaging autonomous control of the vehicle in response to risky driving behavior from the human operator. FIG. 5 describes additional processes for passive ADAS, including the presentation of driver alerts and warnings to the human operator.

Returning to the description of FIG. 4, process 400 includes an operation 422 for identifying deviations between driver response actions 402 and prescriptive response actions 112, generated by conditional imitation learning model 101. In many implementations, operation 422 involves computing a cross entropy value between driver response actions 402 and prescriptive response actions 112. The cross entropy calculation is a loss function recognizable to a user skilled in the art as an approach for computing the risk associated with an output (e.g., driver response actions 402) in view of an expected value (e.g., prescriptive response actions 112). In the context of operation 422, the risk can be similarly thought of as a measure of how far a driver's behavior deviates from the behavior prescribed by the conditional imitation learning model 101. For example, in an E2E artificially intelligent CAS system, a driver continuing to accelerate as they approach a parked vehicle ahead will be assigned a larger risk value when compared to the prescribed response action of prompt braking in response to the imminent collision with the parked vehicle. In operation 442, the cross entropy can be standardized (e.g., to a scale of [0, 1] that increases proportionately with risk) to obtain an interpretable risk value. A pre-determined risk metric threshold, such as 0.5, 0.6, or 0.7, can be assigned to the risk metric. In decision 462, the risk metric output associated with the cross entropy value between driver response actions 402 and prescriptive response actions 112 can be compared to the pre-determined threshold value. If the risk value is above the threshold, the risk is classified as unacceptable. If the risk value is below the threshold, the risk is classified as acceptable. When an unacceptable risk is detected, autonomous driving model 100 including conditional imitation learning model 101 acquires autonomous control of the vehicle in operation 481 to eliminate or mitigate risk. In one implementation, the autonomous driving model 100 retains autonomous control for a pre-determined length of time, such as 3 seconds or 30 seconds. When the risk is determined to be acceptable, the human driver retains manual control of the vehicle in operation 483.

In some implementations, a first pre-determined threshold value is assigned to the risk metric that defines a moderate risk, and a second, higher pre-determined threshold value is assigned to the risk metric that defines a high risk. For example, a moderate risk threshold value may be 0.4 while a high risk threshold value is 0.6. If the outputted risk metric for a pair of driver response actions 402 and prescriptive response actions 112 is below 0.4, the driver retains manual control. If the outputted risk metric for a pair of driver response actions 402 and prescriptive response actions 112 is above 0.4 but less than 0.6, the driver retains manual control and a driver alert warning the driver of the elevated risk (e.g., a visual warning or an alert sound) is presented towards the driver to encourage the driver to correct their behavior. If the outputted risk metric for a pair of driver response actions 402 and prescriptive response actions 112 is above 0.6, the autonomous driving model 100 acquires autonomous control of the vehicle.

In many implementations, semi-autonomous driving process 400 is employed as a CAS tool. Further features of the disclosed E2E, artificially intelligent CAS including passive ADAS features such as driver alerts and displayed driving guidance will be discussed further below with reference to FIGS. 5, 6A-D, and 7A-D.

### Collision Avoidance System and Driver Alerts

FIG. 5 is a schematic diagram 500 showing the generation of collision avoidance data 528 from the prescriptive outputs 112 of an end-to-end autonomous driving model 100, in accordance with certain implementations of the present disclosure. Similarly to previous descriptions of model 100, the autonomous driving model 100 processes environmental driving data with reference to a present driving state including image data 102a, non-camera data 102b like LiDAR data, and a directive condition 102c related to an intended path. The input data is pre-processed in layer 103 to generate a set of input embeddings 502, including both token embeddings (e.g., tokenized image data by a convolutional layer) and positional embeddings to retain location data within the input data. The pre-processing step further includes tokenizing the environmental data to generate environmental data tokens, mapping the environmental data tokens to a reduced dimensional vector space to produce environmental data embeddings, and adding the environmental data embeddings to positional embeddings to generate input embeddings 502 for the disclosed E2E neural network, wherein the positional embeddings preserved spatial information for the environmental data tokens. The input embeddings are processed by conditional imitation learning model 101, further including processing the generated input embeddings 502, combined with compressed embeddings from nine or more earlier driving states over at least three seconds, using encoding layer 104 and generating, as output, a compressed embedding for the present driving state 108 using compression layer 106. Classification head 110 generates prescriptive steering and speed control actions 112 in response to the present driving state.

Many implementations of the disclosed CAS system and methods illustrated by process 500 further include extracting a set of attention weights 524 from model 101, and generating, using the positional embeddings, an attention map 526 including a projection of the extracted attention weights. A user skilled in the art will recognize the meaning of attention weights within a transformer model, leveraging attention weights to infer the importance of various input features and tokens, and generation of an attention map to visualize attention as an interpretability technique for transformer processing. A magnitude of a particular attention weight 524 increases proportionally to an importance of the particular attention weight in generating the prescriptive steering and speed actions. By using the positional embeddings, the attention weight associated with a particular token can be used to infer particular regions within the data, such as a LiDAR map or a camera image, that were important to the generated output 112.

In various implementations, extraction of attention weights and generation of an attention map can be leveraged to detect important objects or regions surrounding the vehicle (e.g., a detected object that is in close proximity to a vehicle, a red light, or an ending lane) and present the detection information towards the driver to assist the driver's decision making. An object can be implicitly detected within a region of an area of real space surrounding the vehicle based on (i) a comparison of an average attention weight value within the region and another average attention weight value within one or more adjacent regions and (ii) the positional embeddings. Examples further illustrating the use of attention maps, generated by projecting the attention weights onto an image or a display, for object detection are explained with reference to FIGS. 6A-D and 7A-D.

Additional collision avoidance data 528 can be generated from a combination of the prescriptive response action 112, the current response action 512 (e.g., a driver's response action during manual control such as response action 412 of process 400) and/or the attention map 526. For example, a risk metric computed as described with reference to process 400 can be presented towards the driver as a scaled value, a scale, or a classification (e.g., projecting the word “RISK!” or emitting a beeping tone). The prescriptive response action 112 can be presented towards the driver, such as a suggested speed, an instruction to accelerate or brake, or a suggested correction to the steering wheel orientation for lane keeping or collision avoidance.

In some implementations, the driver is presented with a video feed from one or more cameras coupled to the vehicle, similar to the commonly implemented “back-up camera” or “360 camera” views included in a vehicle's dashboard, or a map diagram of the vehicle and surrounding area indicating sensor data from LiDAR (e.g., proximity indicators demonstrating that the front or rear of a vehicle is in close proximity to another object). The camera feed or re-generated map graphic presented to the driver can include an attention map overlayed onto the camera feed or graphic as a heat map, coloring regions around the vehicle that are in close proximity to a detected object or objects detected near the vehicle in close proximity to the vehicle. In other implementations, the technology disclosed includes a heads-up display (HUD) projected from the vehicle dashboard such that the generated attention map can be transformed and projected directly onto the heads up display so that the driver need not take their eyes off the road to see objects detected as important. This may be considered augmented reality. Whether the graphical user interface display is a screen display on the driver's dashboard or a HUD, the display may further include useful information such as a prescribed action 112 or a risk metric.

FIGS. 6A-D show a first example graphical user interface for a collision avoidance system. A first example is shown with reference to collision avoidance user interface 600A in FIG. 6A. In the video from which this frame was captured, there is a vehicle ahead 608 that is in the same left hand fast lane as the driver and a vehicle to the right that is exiting the road. Collision avoidance user interface 600A is a HUD presented towards the driver as a projection above the dashboard. In the bottom lefthand corner, we see a trio of meters corresponding respectively to the prescribed acceleration from an AI 612 (i.e., autonomous driving model 100), the current acceleration executed by the human driver 614, and a risk 616. As shown in FIG. 6A, the AI 612 currently recommends a moderate acceleration value, whereas the driver 614 is currently slightly decelerating, despite being the fast lane. A risk metric, which can be computed using process 400, is presented as a very high risk level in risk meter 616. Accordingly, the driver is presented with a large “ACCELERATE” alert 604 in all capital letters within a bright red box at the top of the screen. Intuitively, this makes sense, as it is dangerous to suddenly slow or stop your vehicle on a busy roadway. In the bottom center, we see navigational directional cues 618 presented towards the driver in the format of direction “whiskers.” A black, solid line arrow shows the instructed direction per the navigational directions. A green arrow shows the prescribed orientation from model 100 to both avoid a collision and stay on route. A dashed-line, white arrow shows the current direction of the vehicle in response to the driver's current steering wheel orientation. While the current driver actions and prescribed AI actions are similar for steering in example FIG. 6A, the driver is able to use navigation direction cues 618 as an informative tool to guide vehicle maneuvering. A heat map is projected onto display 600A from attention weights extracted from model 101. Accordingly, a vehicle ahead in the same lane is brightly lit up as a red region 608. Region 608 is considered important to model 101, and this information is communicated to the driver via the heat map.

A second example is shown with reference to collision avoidance user interface 600B in FIG. 6B, containing many of the same features as shown in interface 600A but a different driving scenario. Again, in the bottom lefthand corner, we see acceleration meters for the AI 632 operating in shadow mode and the human driver 634. In the illustrated example within interface 600B, the prescribed acceleration for AI 632 and the actual acceleration for driver 634 are similar, so there is no instruction presented to the driver to accelerate or brake. However, the navigation directional cues 638 indicate that the driver's steering angles to the right as the road bends to the left. The driver's behavior deviates substantially from the prescribed output actions from model 101. The navigation directs the vehicle to stay straight with a slight right lean, as indicated by the solid black arrow. The solid green arrow, illustrating the prescribed output steering orientation from model 101, aligns similarly to the solid black arrow. As indicated by the white dotted-line arrow curving far to the right, the human driver is currently swerving far to the right. If the driver continues on this route, they may swerve out of their lane, or belatedly take the exit seen to the right of the display 600B. The potential lane departure introduced by the driver's steering behavior introduces an imminent collision risk, as indicated by the large risk value indicated by risk meter 636. Accordingly, the driver is presented with a large “GO LEFT” alert 624 in all capital letters within a red box at the top of the screen. The alert means turn the wheel to the left, relative to the current steering. Again, the driver also sees a heat map showing important regions of the display in a bright-red colored region 628.

A third example is shown with reference to collision avoidance user interface 600C in FIG. 6C, containing many of the same features as shown in interfaces 600A and 600B but a different driving scenario. In the video from which this frame was taken, the driver was rolling toward the crosswalk, despite a red light signal. In 600C, that the vehicle is approaching an intersection with a stoplight. Again, in the bottom lefthand corner, we see acceleration meters for the AI 652 operating in shadow mode and the human driver 654. The prescribed acceleration for AI 652 is to decelerate in accordance with the red light 647 called out by the heat map. The driver meter 654 shows that the driver is still currently slightly accelerating. The AI prescribed action in 652 is braking. There is a low risk (656) associated with the driver's omission of braking at this point, which would rise as the crosswalk nears. The large “BRAKE” alert 644 in all capital letters anticipates the need to stop accelerating and start breaking. However, the navigation directional cues 638 indicate that the navigational instruction (solid black arrow), the AI prescribed orientation (solid green arrow) and the current driver's steering wheel orientation (dotted white line arrow) all agree in pointing straight. Again, the driver also sees a heat map showing important regions of the display including a bright-red colored region 648 overlayed on a “No Right Turn” sign, another bright-red colored region 647 overlayed on a red stoplight, and a lighter colored region 646 indicating importance over the crosswalk ahead of the vehicle. Regions 647 and 648 both appear in darker color shades than region 646, corresponding to a higher degree of importance for the AI.

A fourth example 600D is shown in FIG. 6D, with a similar environment as in 600C, but with a pedestrian 668 in the crosswalk and the user speeding up 674 through the red light 665. The vehicle appears to be stopped at or approaching the same intersection in both 600C and 600D with a crosswalk directly in front of the vehicle, and according to navigational directional cues 678, the vehicle is still oriented in a forward direction. The AI meter 672 shows that the prescribed responsive action from the AI is still to decelerate, but the driver meter 674 shows that the driver is accelerating the vehicle. In example 600D, a pedestrian is now in the crosswalk. According to the heat map of example 600D, the stoplight region 665 is still a bright red, corresponding to a high degree of importance. The crosswalk is still emphasized in the heat map, noted in region 667, but the majority of the crosswalk region is still a cooler shade (i.e., less important) than the stoplight region 665 for the AI decision-making process. However, a bright red region 668 of the heat map overlaps with the feet of the pedestrian within the crosswalk, indicating that the pedestrian was also determined to be a highly important region for the AI in deciding to decelerate. Accordingly, the risk meter 676 shows a much higher level of risk when a pedestrian is within the crosswalk for example 600D than for the same intersection without a pedestrian in the crosswalk for example 600C.

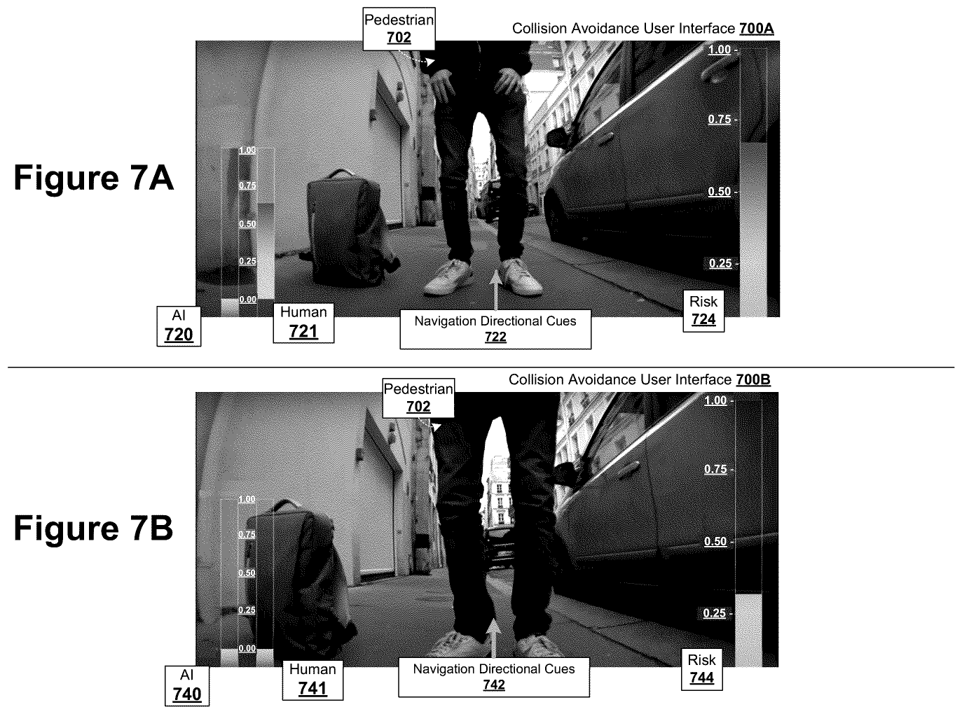

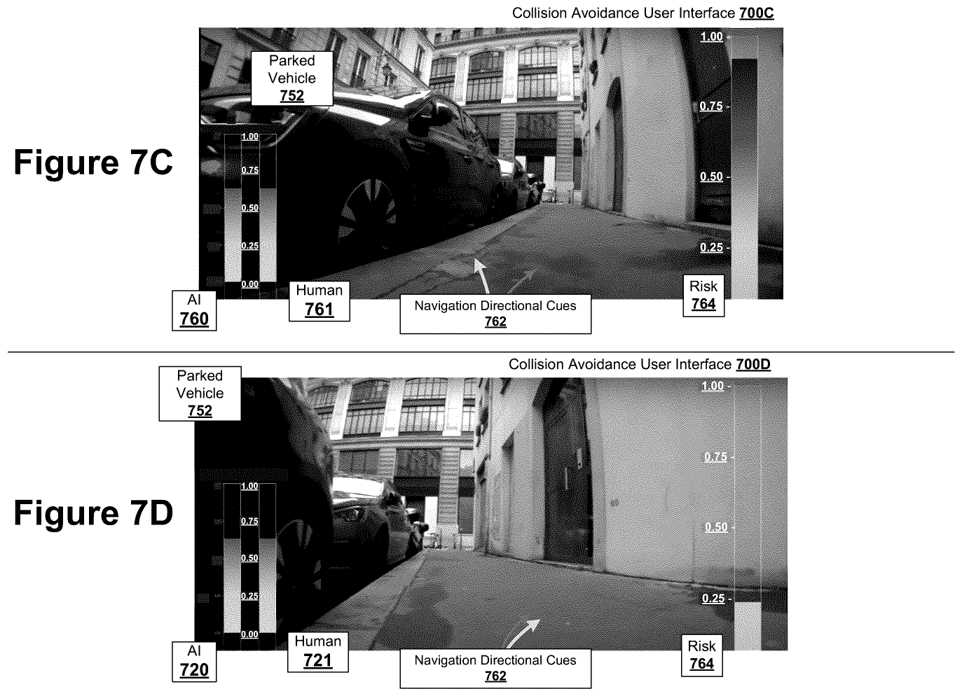

FIGS. 7A-D show a second example graphical user interface for a collision avoidance system. While the graphical user interface shown in FIGS. 7A-D corresponds to a local delivery robotic transporter, as described further in commonly-owned U.S. Patent Applications identified above, it is to be understood that a similar user interface can be applied for a road vehicle as well. Moreover, a user skilled in the art will recognize that the example interfaces within FIGS. 6A-D and 7A-D are provided for illustrative purposes that should not be considered limiting, and many additional various displays in other implementations can be inferred from the examples provided.

In FIG. 7A, an example interface 700A shows similar prescriptive and actual acceleration meters for an AI 720 and a human operator 721, navigational directional cues 722, and a risk meter 724. The prescriptive and actual direction are exactly coincident, so only one directional cue is visible. In the display, we see that the transporter robot is approaching a pedestrian 702 without room to pass on either side, due the suitcase and parked car. The human operator continues to accelerate per human operator acceleration meter 721 and the green directional arrow 722. Without immediate braking intervention, the robot will soon collide with the pedestrian 702. The AI acceleration meter 720 shows that the AI-generated prescriptive output action includes braking to avoid colliding with the pedestrian 702. The risk associated with the current operator behavior is very high, as shown in risk meter 724, as a result of the deviation between the human operator behavior and the AI-generated prescriptive outputs.

Next, in example 700B, we see the same scenario again as in 700A but in example 700B, the human operator has executed braking in accordance with the recommended AI action as shown by meters 740 and 741. Accordingly, the robot transporter is less likely to collide with pedestrian 702 and the risk shown in meter 744 is decreased from previously in example 700A.

FIGS. 7C-D similarly correspond to a robot transporter driving on a sidewalk, but the displayed examples 700C and 700D each show a scenario in which the robot transporter is turning to the left and will collide with a parked vehicle 752 if the path is not corrected. In contrast to example 700A, the problematic behavior can be corrected by changing the orientation of the robot without needing to change the speed. In example 700C, the AI-recommended acceleration and human operator acceleration control are similar per meters 760 and 761, but there is a substantial difference in the prescribed steering orientation and true current steering orientation, as shown by navigational cues 762. The white arrow shows the true current steering orientation from the manual human operator control, which is tilted towards the left and directly facing the parked vehicle 752. The green arrow shows that the AI recommends turning the steering orientation far to the right to correct course and avoid a collision with parked vehicle 752. The risk, as shown in meter 764, is currently very high due to the difference between the true current steering orientation and the AI-generated prescribed steering orientation. A human operator can utilize the driver alert information provided on the screen (e.g., the navigational directional cues 762 and risk meter 764) to correct the current driving behavior, thereby mitigating the risk of an imminent collision.

Accordingly, in example 700D, the navigation directional cues 762 now show that the green arrow (indicating the AI-recommended steering orientation) is turned to the right in agreement with the white arrow (indicating the human operator's steering orientation) and the robot is no longer facing the parked vehicle 752. The risk is now much lower, as shown in meter 764. In some implementations, the technology disclosed may execute active ADAS measures for any of the provided example driving tasks above. For example, in the example driving task shown in FIGS. 7C-D applying passive collision avoidance ADAS in the form of a driver warning, the high level risk associated with the driver behavior in example 700C can trigger a transition to autonomous control such that the AI-prescribed braking action is executed.

### Computer System

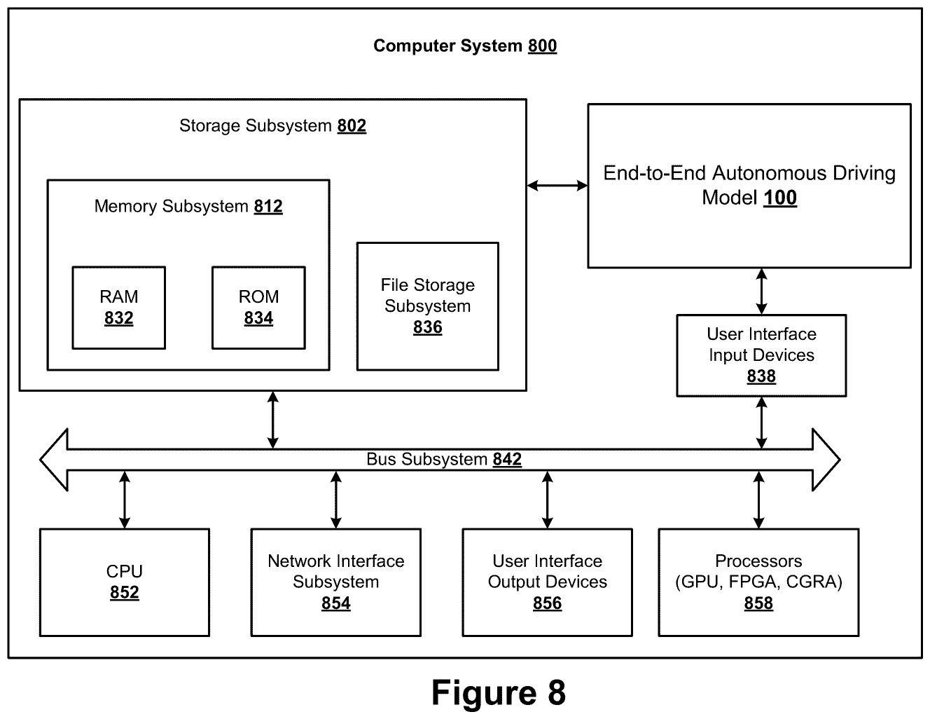

FIG. 8 illustrates a computer system 800 that can be used to implement the technology disclosed, in accordance with certain implementations of the present disclosure. Computer system 800 includes at least one central processing unit (CPU) 852 that communicates with a number of peripheral devices via bus subsystem 842. These peripheral devices can include a storage subsystem 802 including, for example, memory devices and a file storage subsystem 836, user interface input devices 838, user interface output devices 856, and a network interface subsystem 854. The input and output devices allow user interaction with computer system 800. Network interface subsystem 854 provides an interface to outside networks, including an interface to corresponding interface devices in other computer systems.

In one implementation, the model 100 is communicably linked to the storage subsystem 802 and the user interface input devices 838. In another implementation, the control unit 826 of the depot and the control unit 832 of the transporter are also communicably linked to the storage subsystem 802 and the user interface input devices 838. User interface input devices 838 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 800.

User interface output devices 856 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 800 to the user or to another machine or computer system.

Storage subsystem 802 stores programming and data constructs that provide the functionality of some or all of the modules and methods described herein. These software modules are generally executed by processors 858. Processors 858 can be graphics processing units (GPUs), field-programmable gate arrays (FPGAs), application-specific integrated circuits (ASICs), and/or coarse-grained reconfigurable architectures (CGRAs). Processors 858 can be hosted by a deep learning cloud platform such as Google Cloud Platform™, Xilinx™, and Cirrascale™. Examples of processors 878 include Google's Tensor Processing Unit (TPU)™, rackmount solutions like GX4 Rackmount Series™, GX16 Rackmount Series™, NVIDIA DGX-1™, Microsoft' Stratix V FPGA™, Graphcore's Intelligent Processor Unit (IPU)™, Qualcomm's Zeroth Platform™ with Snapdragon Processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 812 used in the storage subsystem 802 can include a number of memories including a main random access memory (RAM) 832 for storage of instructions and data during program execution and a read only memory (ROM) 834 in which fixed instructions are stored. A file storage subsystem 836 can provide persistent storage for program and data files, and can include a hard disk drive, a floppy disk drive along with associated removable media, a CD-ROM drive, an optical drive, or removable media cartridges. The modules implementing the functionality of some implementations can be stored by file storage subsystem 836 in the storage subsystem 802, or in other machines accessible by the processor. Bus subsystem 842 provides a mechanism for letting the various components and subsystems of computer system 800 communicate with each other as intended. Although bus subsystem 842 is shown schematically as a single bus, alternative implementations of the bus subsystem can use multiple busses.

Computer system 800 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 800 depicted in FIG. 8 is intended only as a specific example for purposes of illustrating the preferred implementations of the present invention. Many other configurations of computer system 800 are possible having more or less components than the computer system depicted in FIG. 8.

Each of the processors or modules discussed herein may include an algorithm (e.g., instructions stored on a tangible and/or non-transitory computer readable storage medium) or sub-algorithms to perform particular processes. The model 100 is illustrated conceptually as a collection of modules, but may be implemented utilizing any combination of dedicated hardware boards, DSPs, processors, etc. Alternatively, system 100 may be implemented utilizing an off-the-shelf PC with a single processor or multiple processors, with the functional operations distributed between the processors. As a further option, the modules described below may be implemented utilizing a hybrid configuration in which some modular functions are performed utilizing dedicated hardware, while the remaining modular functions are performed utilizing an off-the-shelf PC and the like. The modules also may be implemented as software modules within a processing unit.

Various processes and steps of the methods set forth can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive.

A processor that is used to run an algorithm or other process set forth herein may comprise a microprocessor. The microprocessor may be any conventional general purpose single- or multi-chip microprocessor such as a Pentium™ processor made by Intel Corporation. A particularly useful computer can utilize an Intel Ivybridge dual-16 core processor, LSI raid controller, having 168 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

### Some Particular Implementations

We describe some particular implementations and features usable for providing driver assistance alerts to a driver using an E2E model trained for autonomous and semiautonomous driving. Many implementations include a method of providing driver assistance alerts to a driver. The method includes receiving environmental data for a sequence of driving states including at least video from a camera, returns from an optical sensor, and location data from a GNSS receiver, wherein the camera, the optical sensor, and the GNSS receiver are coupled to a processor carried by a vehicle and processing the environmental data as input to an end-to-end neural network. The end-to-end neural network is trained to generate prescriptive steering and speed control actions in response to a present driving state. The method includes analyzing hidden layer data and output data from the end-to-end neural network to estimate collision avoidance data, wherein the collision avoidance data includes, at least one or more detected objects within the video from the camera, a directional cue. The directional cue is a projection overlay based on the prescriptive steering control actions onto a heads up display, and a risk metric that quantifies a dissimilarity between the generated prescriptive steering and speed control actions, and received driver steering and speed control actions. The method also includes presenting a user interface to the driver including driver assistance alerts based on the collision avoidance data.

We describe some particular implementations related to the method for providing driver alerts. The directional cue may be projected onto the heads up display. Within the user interface a dynamic whisker arrow may indicate a prescriptive vehicle orientation relative to a current vehicle orientation based on the generated prescriptive steering control actions. A prescriptive whisker can be juxtaposed with a current human action whisker.

In some implementations, obtaining the risk method further includes calculating a cross entropy between the generated prescriptive steering and speed control actions and current driver steering and speed control actions and standardizing the cross entropy calculation to generate a risk metric output. The risk metric output is a proxy for an imminent collision risk and increases proportionally as the current driver steering and speed control actions deviate further from the generated prescriptive steering and speed control actions.

One implementation includes, in response to the response metric output, maintaining a manual driving mode while the risk metric output is less than a pre-determined threshold value, wherein the manual driving mode includes permitting the vehicle to apply the current driver steering and speed control input actions, and engaging in an autonomous driving mode when the risk metric output is equal to or greater than the pre-determined threshold value, wherein the autonomous driving mode includes causing the vehicle to apply the prescriptive steering and speed control input actions. One implementation further includes categorizing the risk metric into risk levels by defining a particular risk level as including risk metric outputs within a pre-determined range between a lower boundary value and an upper boundary value.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

For some implementations, the user interface presents, to the driver, a quantitative risk including the risk metric output or a categorical risk including the risk level based on the risk metric value. In other implementations, the user interface further presents the generated prescriptive steering and speed control actions to the driver. The driver alerts, such as the risk or a prescribed response action can include a visual display, an audio signal, or a haptic signal. The visual display may be a display screen or a HUD.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

One implementation includes pre-processing the environmental data prior to being provided to the end-to-end neural network, including tokenizing the environmental data for the present driving state to generate environmental data tokens, mapping the environmental data tokens to a reduced dimensional vector space to produce environmental data embeddings, and adding the environmental data embeddings to positional embeddings to generate input embeddings for the end-to-end neural network, wherein the positional embeddings preserve spatial information for the environmental data tokens.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

Some implementations include a disclosed end-to-end neural network configured for autonomous driving, wherein the end-to-end neural network is a transformer model trained for end-to-end autonomous driving, and the transformer model processing the environmental data further includes processing the generated input embeddings combined with compressed embeddings from nine or more earlier driving states over at least three seconds and generating, as output, a compressed embedding for the present driving state and prescriptive steering and speed control actions in response to the present driving state.

Many implementations further include extracting a set of attention weights from the transformer model, and generating, using the positional embeddings, an attention map including a projection of the extracted attention weights, wherein a magnitude of a particular attention weight increases proportionally to an importance of the particular attention weight in generating the prescriptive steering and speed actions, and an object is implicitly detected within a region of an area of real space surrounding the vehicle based on a comparison of an average attention weight value within the region and another average attention weight value within one or more adjacent regions and the positional embeddings. In one implementation, the one or more detected objects presented within the heads up display further includes color-coding attention weights within the attention map enabling visual identification of implicitly detected objects and projecting an overlay of the color-coded attention map onto a heads up display.

The method can also include storing a history of the video from the camera and the driver assistance alerts presented to the driver within a driving database, wherein the driving database is available for additional data analysis and data auditing after a driving activity is completed.

In some implementations, the disclosed method is leveraged for a driver education tool that provides feedback to a driver while learning a new driving task. For example, the driver education tool can be used for teaching new drivers or specialized forms of driving, like racing. The disclosed method can also be implemented in ADAS tools for safe driving monitoring by logging the history of risk and recorded driving behaviors within the vehicle.

Another method practicing the technology disclosed involves training a neural network to generate driver assistance alert data. The method includes receiving environmental data for a sequence of driving states resulting from human driving, including at least video from a camera, returns from an optical sensor, and location data from a GNSS receiver, wherein the camera, the optical sensor, and the GNSS receiver are coupled to a processor carried by a vehicle. It includes processing the environmental data as input to imitation training of an end-to-end neural network, including training the end-to-end neural network to generate prescriptive steering and speed control actions in response to a present driving state. The training includes analyzing hidden layer data and output data from the end-to-end neural network to estimate collision avoidance data and imitation training of the hidden layer data. The collision avoidance data includes, at least a directional cue and a speed control cue. The directional and speed cues are suitable to generate prescriptive steering and speed control actions projected onto a heads up display or other dashboard display of a vehicle.

The training produces attention weights in the end-to-end neural network's hidden layer data that are indicate areas of the video from the camera that contribute most significantly to the generated prescriptive steering and speed cues.

This method can further include configuring a system that includes the end-to-end neural network and further includes a risk metric generator. The training extends to parameters of the risk metric generator used to generate a normalized risk metric that quantifies a dissimilarity between the generated prescriptive steering and speed control cues and received driver steering and speed control actions that vary from the generated prescriptive steering and speed control actions, whereby the normalized risk metric onto a heads up display or other dashboard display of a vehicle.

This method can be combined with features disclosed in the implementations above and throughout this application which are not individually enumerated or repeated with the set of training features. The reader will understand how features identified in this section can readily be combined with sets of base features identified as implementations.

The technology disclosed can be practiced as a system, method, or article of manufacture. For instance, the technology disclosed can be practiced as a system with a hardware processor, memory coupled to the processor, and instructions executable on the processor that, when executed, cause the system to carry out any of the methods described. Such a system can include connected sensors from which the environmental data are received. Similarly, the technology disclosed can be practiced as computer readable medium impressed with instructions executable on a hardware processor that, when executed, cause a system including the processor to carry out any of the methods described. Such a computer readable medium impressed with instructions for receiving environmental data from sensors.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A computer-implemented method of providing driver assistance alerts to a driver, the method including:
receiving environmental data for a sequence of driving states including at least video from a camera, returns from an optical sensor, and location data from a GNSS receiver, wherein the camera, the optical sensor, and the GNSS receiver are coupled to a processor carried by a vehicle;
processing the environmental data as input to an end-to-end neural network, wherein the end-to-end neural network is trained to generate prescriptive steering and speed control actions in response to a present driving state;
analyzing hidden layer data and output data from the end-to-end neural network to estimate collision avoidance data, wherein the collision avoidance data includes, at least:
one or more detected objects within the video from the camera,
a directional cue, wherein the directional cue is a projection overlay based on the prescriptive steering control actions onto a heads up display, and
a risk metric that quantifies a dissimilarity between the generated prescriptive steering and speed control actions, and received driver steering and speed control actions; and
presenting, to the driver, a user interface including driver assistance alerts based on the collision avoidance data.

2. The computer-implemented method of claim 1, wherein the directional cue projected onto the heads up display within the user interface is a dynamic whisker arrow indicating a prescriptive vehicle orientation relative to a current vehicle orientation based on the generated prescriptive steering control actions.

3. The computer-implemented method of claim 1, wherein obtaining the risk metric further includes:
calculating a cross entropy between the generated prescriptive steering and speed control actions and current driver steering and speed control actions and standardizing the cross entropy calculation to generate a risk metric output,
wherein the risk metric output is a proxy for an imminent collision risk and increases proportionally as the current driver steering and speed control actions deviate further from the generated prescriptive steering and speed control actions.

4. The computer-implemented method of claim 3, further including, in response to the risk metric output:
maintaining a manual driving mode while the risk metric output is less than a pre-determined threshold value, wherein the manual driving mode includes permitting the vehicle to apply the current driver steering and speed control input actions, and
engaging in an autonomous driving mode when the risk metric output is equal to or greater than the pre-determined threshold value, wherein the autonomous driving mode includes causing the vehicle to apply the prescriptive steering and speed control input actions.

5. The computer-implemented method of claim 3, further including categorizing the risk metric into risk levels by defining a particular risk level as including risk metric outputs within a pre-determined range between a lower boundary value and an upper boundary value.

6. The computer-implemented method of claim 5, wherein the user interface presents, to the driver, a quantitative risk including the risk metric output or a categorical risk including the risk level based on the risk metric value.

7. The computer-implemented method of claim 1, wherein the driver assistance alerts include one or more of a visual display, an audio signal, or a haptic signal.

8. The computer-implemented method of claim 1, wherein the user interface further presents the generated prescriptive steering and speed control actions to the driver.

9. The computer-implemented method of claim 1, wherein the environmental data is pre-processed prior to being provided to the end-to-end neural network, the pre-processing further including:
tokenizing the environmental data for the present driving state to generate environmental data tokens,
mapping the environmental data tokens to a reduced dimensional vector space to produce environmental data embeddings, and
adding the environmental data embeddings to positional embeddings to generate input embeddings for the end-to-end neural network, wherein the positional embeddings preserve spatial information for the environmental data tokens.

10. The computer-implemented method of claim 9, wherein the end-to-end neural network is a transformer model trained for end-to-end autonomous driving, and the transformer model processing the environmental data further includes:
processing the generated input embeddings combined with compressed embeddings from nine or more earlier driving states over at least three seconds and generating, as output, a compressed embedding for the present driving state and prescriptive steering and speed control actions in response to the present driving state.

11. The computer-implemented method of claim 10, further including extracting a set of attention weights from the transformer model, and generating, using the positional embeddings, an attention map including a projection of the extracted attention weights, wherein:
a magnitude of a particular attention weight increases proportionally to an importance of the particular attention weight in generating the prescriptive steering and speed actions, and
an object is implicitly detected within a region of an area of real space surrounding the vehicle based on (i) a comparison of an average attention weight value within the region and another average attention weight value within one or more adjacent regions and (ii) the positional embeddings.

12. The computer-implemented method of claim 11, wherein presenting, via the user interface, the one or more detected objects within the heads up display further includes color-coding attention weights within the attention map enabling visual identification of implicitly detected objects and projecting an overlay of the color-coded attention map onto a heads up display.

13. The computer-implemented method of claim 1, further including storing a history of the video from the camera and the driver assistance alerts presented to the driver within a driving database, wherein the driving database is available for additional data analysis and data auditing after a driving activity is completed.

14. A computer-implemented method of training a neural network to generate driver assistance alert data, the method including:
receiving environmental data for a sequence of driving states resulting from human driving, including at least video from a camera, returns from an optical sensor, and location data from a GNSS receiver, wherein the camera, the optical sensor, and the GNSS receiver are coupled to a processor carried by a vehicle;
processing the environmental data as input to imitation training of an end-to-end neural network, including training the end-to-end neural network to generate prescriptive steering and speed control actions in response to a present driving state;
wherein the training includes analyzing hidden layer data and output data from the end-to-end neural network to estimate collision avoidance data, wherein the collision avoidance data includes, at least:
a directional cue, whereby the directional cue can be projected as a prescriptive steering control action onto a heads up display, and
a speed control cue, whereby the speed control cue can be projected as a prescriptive speed control action onto a heads up display;
whereby attention weights of the end-to-end neural network in the hidden layer data indicate areas of the video from the camera that contribute most significantly to the generated prescriptive steering and speed control actions.

15. The method of claim 14, further including configuring a system including the end-to-end neural network and further including a risk metric generator, including:
training parameters of the risk metric generator to generate a normalized risk metric that quantifies a dissimilarity between the generated prescriptive steering and speed control actions and received driver steering and speed control actions that vary from the generated prescriptive steering and speed control actions, whereby the normalized risk metric onto a heads up display.
